(19) United States
(12) Patent Application Publication
(10) Pub. No.: US 2003/0223608 A1
(43) Pub. Date: Dec. 4, 2003

(54) Turntable for loudspeaker display

(76) Inventor: Peigen Jiang, Sunnyvale, CA (US)

Correspondence Address: PEIGEN JIANG, 306 PORTIA AVE, SUNNYVALE, CA, 94086, US

(21) Appl. No.: 10/158,445

(22) Filed: May 31, 2002

(51) Int. Cl. H04R 29/00; H04R 1/02; H04R 9/06

(52) U.S. Cl. 381/332; 381/333; 381/59

(57) ABSTRACT

A loudspeaker display turntable comprising a horizontally rotary turntable, which is large enough to carry multiple loudspeakers, and the rotation of the platform is motorized and has sensor and control mechanisms to allow operator to control its rotation, that is to rotate and stop each loudspeaker it carrys at a desired location.

### BACKGROUND OF THE INVENTION

(1) Field of the Invention

The present invention relates to a display device for commercial loudspeaker display.

(2) Description of the Prior Art

In commercial settings, multiple stereo or surround sound loudspeakers are normally displayed in the same room for comparison, and they are placed side by side, and played one set at a time for potential customers. The problem with side-by-side placement is that for different loudspeaker sets, their distances to the listener and their acoustic interactions with the room environment are different, due to the fact that the loudspeakers are placed in different locations in the room.

### SUMMARY OF THE INVENTION

Accordingly, the objective of the present invention is to provide a device to carry multiple loudspeakers, and to allows each loudspeaker carried thereon to be easily moved to the same location.

This objective is accomplished with the present invention by employing a horizontally rotary turntable with a platform large enough to carry multiple loudspeakers. The turntable is motorized and has sensors and control mechanism that can rotate each loudspeaker carried thereon to a particular location.

### BRIEF DESCRIPTION OF THE DRAWINGS

FIG. 1 is a top view of the turntable 1 carrying three loudspeakers 2a, 2b and 2c.

FIG. 2 is the schematic of the stop sensor-switch 4.

### DETAILED DESCRIPTION OF THE PREFERRED EMBODIMENT

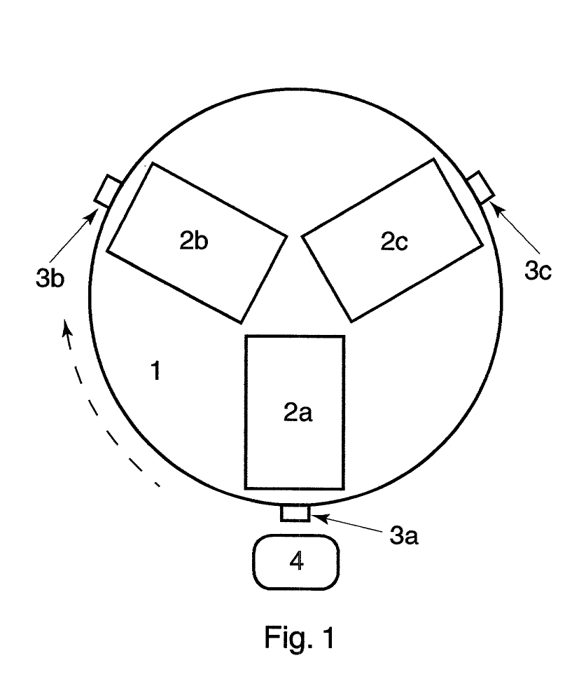

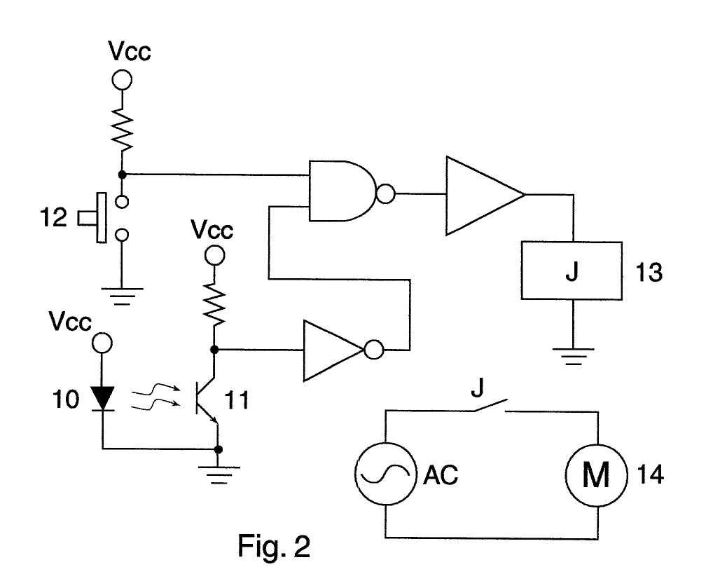

Referring to FIG. 1 and FIG. 2, turntable 1 carries three loudspeakers 2a, 2b and 2c, the rotation of which is driven by electric motor 14, and when said electric motor 14 is turned off, the said turntable 1 stops immediately. Positioning of the loudspeakers is achieved by placing a locator 3 close to each loudspeaker 2, 3a to 2a, 3b to 2b and 3c to 3b, at the circumference of the turntable 1, and by placing the sole stop sensor-switch 4 on the floor with its sensor closely facing toward the circumference of the turntable 1, and at a location when a locator 3 comes in align with the stop sensor-switch 4, its corresponding loudspeaker 2 is placed right at the desired location for display. In this preferred embodiment, since the sensing medium is infra-red light from stop sensor-switch 4, the locators 3a, 3b and 3c are white color reflective stickers, and can be placed anywhere to reflect the positions of the arbitrarily placed loudspeakers 2a, 2b and 2c.

The stop sensor-switch 4 consists of infra-red emitter 10, infra-red sensor 11, manual switch 12 and electric relay 13 and several other common electronic components. When relay 13 is at armature-on, the motor 14 is power-on; and when armature-off, the motor 14 is power-off, and any one of the following two conditions can keep relay 13 stay at armature-on, (1) press down the manual switch 12 by operator; or (2) infra-red sensor 11 receives no infra-red light, that is no reflective locator 3 facing the stop sensor-switch 4.

So at static state, the turntable 1 always rests at a position where a locator 3 facing the stop sensor-switch 4, hence there is always one loudspeaker 2 is placed at the desired location. To rotate another loudspeaker 2 to the desired location, a operator press down the manual switch 12 to start the motor 14, as soon as the locator 3 moves away from the stop sensor-switch 4, manual switch 12 can be released and the motor 14 will keep rotating until the next locator 3 reaches the vicinity of stop sensor-switch 4.

What I claim as my invention is:

1. A method of displaying multiple loudspeakers comprising the rotation of the said loudspeakers by carrying them on a motorized turntable.

2. A control means that controls the rotation of the turntable of claim 1 wherein, further comprising:
a) multiple movable rotary sensors placed at the circumference of the said turntable to reflect the locations of the displayed loudspeakers on the said turntable, and the number of said rotary senors equals the number of the loudspeakers carried by the said turntable;
b) a single movable stationary sensor placed on the floor close to the circumference of the said turntable, at a desired location where the said loudspeakers are expected to be displayed;
c) a control circuit including the said rotary and stationary sensors to allow operator to turn on the electric motor which rotates the said turntable, and hence the loudspeakers carried thereon, and stops it automatically when a said rotary sensor comes a cross the said stationary sensor, so that this rotary senor correspending loudspeaker is rotated to the desired location.
